(19) United States
(12) Patent Application Publication
(10) Pub. No.: US 2004/0090451 A1
(43) Pub. Date: May 13, 2004

(54) Electrical device display help

(76) Inventors: D. Travis Lay, Meridian, ID (US); Erica Baalson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/292,825

(22) Filed: Nov. 12, 2002

(51) Int. Cl. G09G 5/00

(52) U.S. Cl. 345/713; 345/709

(57) ABSTRACT

Disclosed are systems and methods for providing help to users regarding features of an electrical device display. In one embodiment, a system and a method pertain to receiving a help request registered by the user by selection of a help button, determining help content relevant to at least one feature that is currently displayed in the electrical device display, and presenting help content to the user that has been determined to be relevant to the at least one feature.

### FIELD OF THE DISCLOSURE

The present disclosure relates to electrical device displays. More particularly, the disclosure relates to systems and methods for providing help to a user regarding one or more features presented to the user with an electrical device display.

### BACKGROUND

Many electrical devices comprise displays that are used to control the operation of the electrical device. Examples of such electrical devices include office-type equipment such as printers, photocopiers, facsimile machines, scanners, and multi-function peripheral (MFP) devices. In addition, displays are often used in other environments such as automated teller machines (ATMs), gasoline pumps, cash registers, etc.

The displays used in the above-noted applications typically comprise liquid crystal displays (LCDs) that may or may not be touch-sensitive (in which case they may be referred to as touchscreens). Such displays normally provide graphical representations of various selectable features, for instance buttons, that the user may select by either touching the display with one's finger or scrolling through the features using an actual control panel button. In that no physical buttons or other features are provided by the display, the features displayed in the display can be changed such that various different sets of features can be presented to the user for selection. By way of example, these different sets of features may be accessed by selecting different tabs of virtual folders or by selecting other features in a menu drill-down procedure.

Due to the different features presented with the display, the user may navigate through several screens of a menu system until locating a given feature that pertains to a function in which the user is interested. If during the user's menu navigation a feature is encountered with which the user is unfamiliar, the user may wish to obtain help as to that feature. Often, such help may be obtained by locating a “Help” button presented in one of the screens of the menu system with which a query can be entered as to the unfamiliar feature. Unfortunately, however, the user may need to back track through several screens of the menu system until finding such a Help button. In such a case, it is possible for the user to forget the name of the feature about which help is needed. Therefore, the user may need to go back to the menu system screen at which the feature was first encountered and again back track to the screen at which the Help button is provided.

Even where the user remembers the name of the feature about which help is needed, the user may have difficulty relocating the feature (e.g., button) after help has been obtained. This may particularly be the case where the feature is “buried” deep within the menu system on a low level screen.

### SUMMARY

The present disclosure relates to providing help to users regarding features of an electrical device display. In one embodiment, a system and a method pertain to receiving a help request registered by the user by selection of a help button, determining help content relevant to at least one feature that is currently displayed in the electrical device display, and presenting help content to the user that has been determined to be relevant to the at least one feature.

### BRIEF DESCRIPTION OF THE DRAWINGS

The invention can be better understood with reference to the following drawings. The components in the drawings are not necessarily to scale.

FIG. 1 is a schematic view of an embodiment of a system in which electrical device display help can be provided to a user.

FIG. 2 is a block diagram of an embodiment of an electrical device shown in FIG. 1.

FIG. 3 is a block diagram of an embodiment of a computing device shown in FIG. 1.

FIG. 4 is a schematic representation of an embodiment of a screen presented in a display of the electrical device of FIG. 1.

FIG. 5 is a flow diagram that illustrates an embodiment of a method for providing help to a user regarding an electrical device display.

FIG. 6 is a flow diagram that illustrates an embodiment of operation of a help manager of the electrical device shown in FIG. 2.

FIG. 7 is a flow diagram that illustrates an embodiment of operation of a help content download manager of the computing device shown in FIG. 3.

FIG. 8 is a schematic representation of a first embodiment of help content presented to a user with an electrical device display.

FIG. 9 is a schematic representation of a second embodiment of help content presented to a user with an electrical device display.

### DETAILED DESCRIPTION

As noted above, it can be difficult to obtain help regarding a particular electrical device display feature given that the “Help” button is normally only made available for selection in a particular screen of the menu system used to convey visual information to the user. As is described in greater detail below, such help can be more easily obtained by the user where the electrical device provides an actual, physical help button on the control panel or is configured to present an onscreen, virtual help “button” to the user regardless of the particular menu system screen to which the user has navigated.

Disclosed in the following are systems and methods that facilitate the above-described provision of help. Although specific systems and methods are described herein, these systems and methods are mere embodiments that are provided by way of example for purposes of describing the manners in which help can be provided as to features presented in an electrical device display.

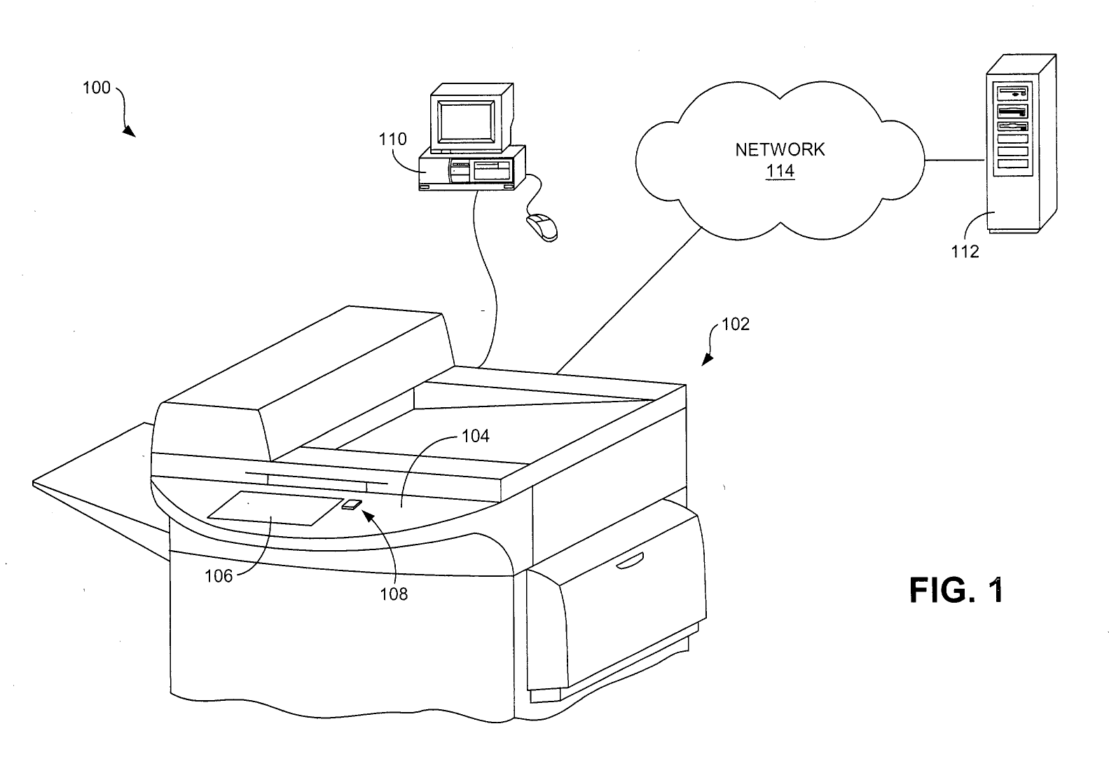

Referring now in more detail to the drawings, in which like numerals indicate corresponding parts throughout the several views, FIG. 1 illustrates a system 100 with which electrical device display help can be provided to a user. The system 100 includes an electrical device 102. As illustrated in FIG. 1, the electrical device 102 may comprise a printer. More generally, however, the electrical device 102 can comprise any device, machine, or equipment that includes a display through which information is conveyed to the user and through which the user can control operation of the device, machine, or equipment. Accordingly, the electrical device can, alternatively, comprise another office-type piece of equipment such as photocopier, facsimile machine, scanner, or multi-function peripheral (MFP) device, or a non-office machine such as an automated teller machine (ATM), gasoline pump, cash register, etc.

Irrespective of its particular nature, the electrical device 102 includes a control panel 104 that comprises a display 106 with which various screens containing selectable features can be presented to the user. By way of example, the display 106 comprises a liquid crystal display (LCD) that is touch-sensitive. In addition to the display 106, the control panel 104 may, optionally, include an actual, physical help button 108 that may be selected regardless of what screens and/or features are shown in the display 106. The term “physical button” is used broadly herein to identify substantially any physical, selectable control panel feature.

The electrical device 102 may be connected, either directly or wirelessly, to a local computing device 110, which may comprise a personal computer (PC) and/or a remote computing device 112, which may comprise a server, via a network 114. As is discussed below, either computing device 110, 112 may serve as a source for help content. In addition, the local computing device 110 may further provide a means for displaying help content to the user. Where used, the network 114 typically comprises one or more sub-networks that are communicatively coupled to each other. By way of example, these networks can include one or more local area networks (LANs) and/or wide area networks (WANs). In some embodiments, the network 114 may comprise a set of networks that forms part of the Internet.

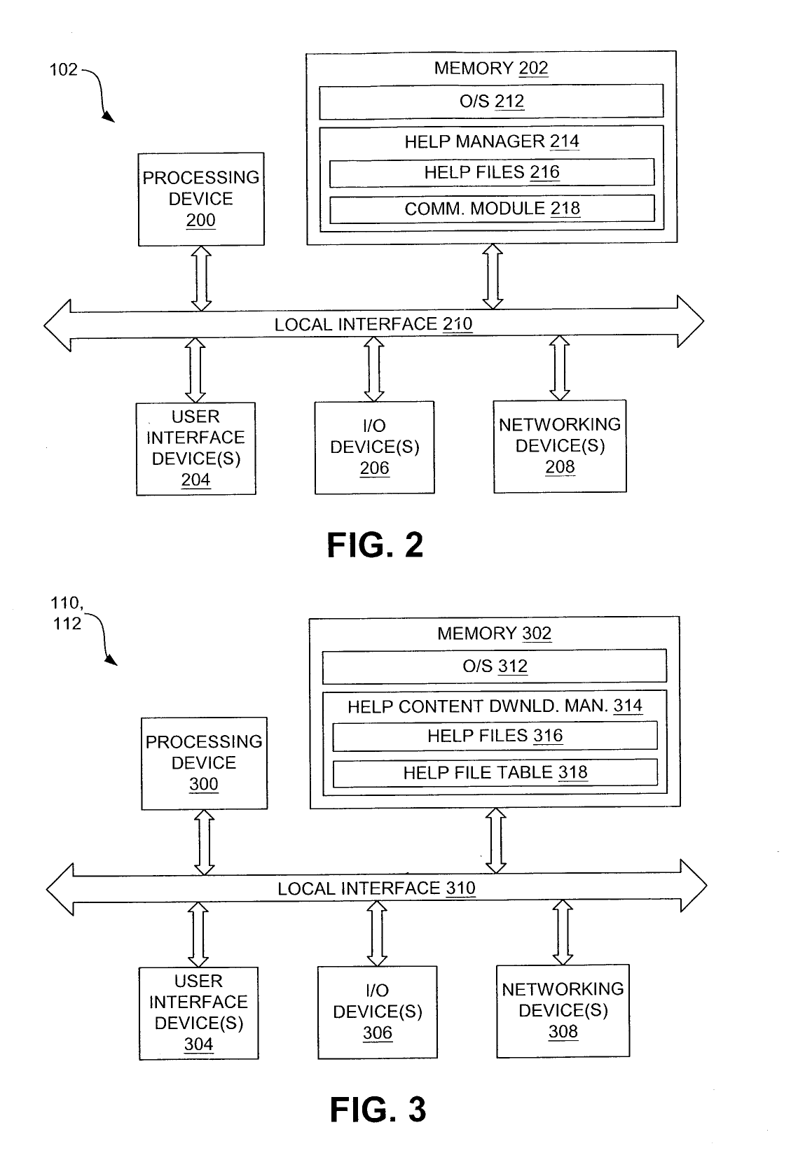

FIG. 2 is a block diagram illustrating an example architecture for the electrical device 102 shown in FIG. 1. As indicated in FIG. 2, the electrical device 102 can comprise a processing device 200, memory 202, user interface devices 204, input/output (I/O) devices 206, and networking devices 208, each of which is connected to a local interface 210. The processing device 200 can include any general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the electrical device 102. The memory 202 can include any one of a combination of volatile memory elements (e.g., random access memory (RAM) and non-volatile memory elements (e.g., hard drive, compact disc read only memory (CDROM), etc.).

The user interface devices 204 comprise those components with which the user can interact with the electrical device 102. As indicated in FIG. 1, these devices 204 include a display 106 and, optionally, a help button 108. In addition to these elements, various other buttons or keys may be provided, for example on the device control panel 104.

The I/O devices 206 comprise components used to facilitate connection of the electrical device 102 to other devices such as, for example, a PC. Therefore, these devices 206 can, for instance, comprise one or more serial, parallel, small system interface (SCSI), universal serial bus (USB), or IEEE 1394 (e.g., Firewire™) connection devices. The networking devices 208 comprise the various components used to transmit and/or receive data over the network 114 (where provided). By way of example, the networking devices 208 include a device that can communicate both inputs and outputs, for instance, a modulator/demodulator (e.g., modem), a radio frequency (RF) or infrared (IR) transceiver, a network card, etc.

The memory 202 comprises various programs (in software and/or firmware) including an operating system (O/S) 212 and a help manager 214. The O/S 212 controls the execution of other programs and provides scheduling, input-output control, file and data management, memory management, and communication control and related services. The help manager 214 is used to facilitate the provision of help to a user regarding features presented in the device display 106. As indicated in FIG. 2, the help manager 214 comprises, or may access, help files 216 that contain help content that may be presented to the user, as well as a communication module 218 that be used to query a help content source (e.g., computing devices 108 and/or 110) for other help content. Examples of operation of the help manager 214 are provided below.

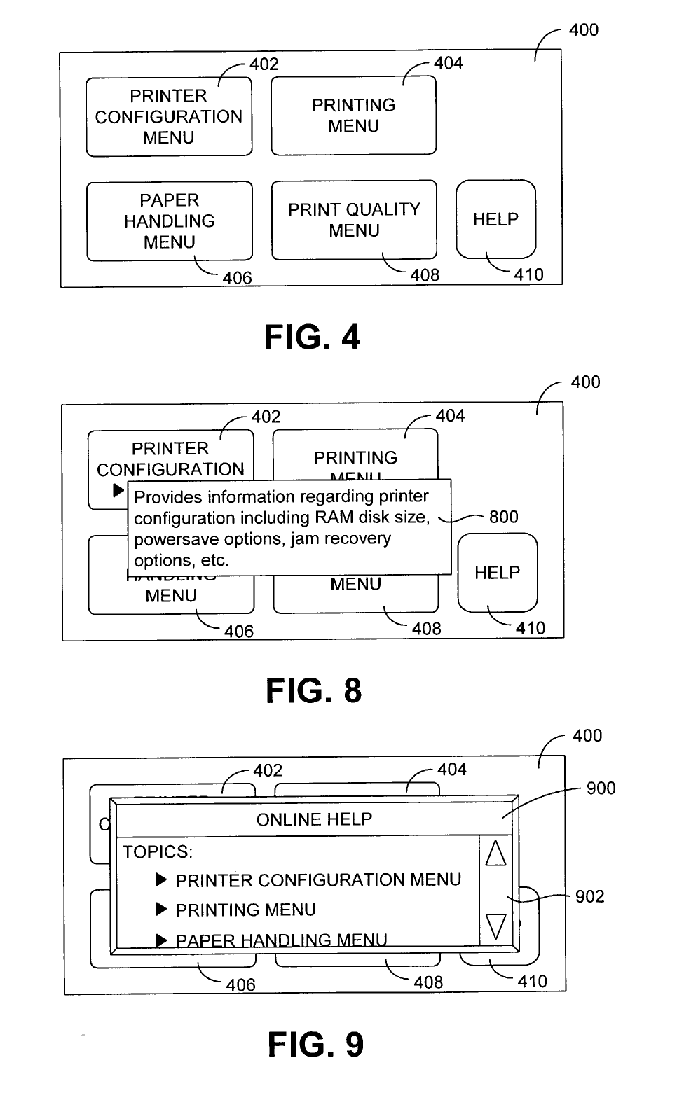

As an alternative to having an actual, physical help button 108 such as that identified in FIG. 1, an onscreen, virtual help button may be presented to the user in the electrical device display 106. An example of this is shown in FIG. 4. As illustrated in this figure, a particular “screen” 400 may be provided in the electrical device display. This screen may comprise a layer of the menu system used to present content to the user with the display. In the example of FIG. 4, the screen 400 includes a “Printer Configuration Menu” button 402, a “Printing Menu” button 404, a Paper Handing Menu” button 406, and a “Print Quality Menu” button 408. In addition, presented in the screen 400 is a virtual “Help” button 410. As is described below, this Help button 410, or a variation thereof, may be presented in every screen presented in the electrical device display 106 such that help will always be available, regardless of the layer of the menu system to which the user has navigated. As used, herein, the term “virtual button” is used to generally describe any selectable feature presented in the display 106. Therefore, the term includes features not specifically configured to emulate an actual, physical button.

FIG. 3 is a block diagram illustrating an example architecture for one or both of the computing devices 110, 112 shown in FIG. 1. As indicated in FIG. 3, each computing device 110, 112 can comprise a processing device 300, memory 302, user interface devices 304, I/O devices 306, and networking devices 308. Each of these components is connected to a local interface 310 that, by way of example, comprises one or more internal buses. The processing device 300 is adapted to execute commands stored in memory 302 and can comprise any custom made or commercially available processor, a central processing unit (CPU) or an auxiliary processor among several processors associated with the computing device, a semiconductor based microprocessor (in the form of a microchip), or a macroprocessor. The memory 302, can comprise substantially any volatile or non-volatile memory, or combination thereof.

The user interface devices 304 typically comprise those components typically used with computing devices, such as a keyboard and a mouse. The I/O devices 306 and networking devices 308 can have configurations similar to like-named components identified above with reference to FIG. 2. The memory 302 includes an operating system 312 and a help content download manager 314 that facilitates download of help content to the electrical device 102. As indicated in FIG. 2, the manager 314 can include, or access, one or more help files 316, for example by first consulting a help file table 318. Examples of operation of the help content download manager 314 are provided in the discussions below.

Various programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The disclosed programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, examples of operation of the systems will now be discussed. In the discussions that follow, flow diagrams are provided. Any process steps or blocks in these flow diagrams may represent modules, segments, or portions of code that include one or more executable instructions for implementing specific logical functions or steps in the process. Although particular example steps are described, alternative implementations are feasible. Moreover, steps may be executed out of order from that shown or discussed, including substantially concurrently or in reverse order, depending on the functionality involved.

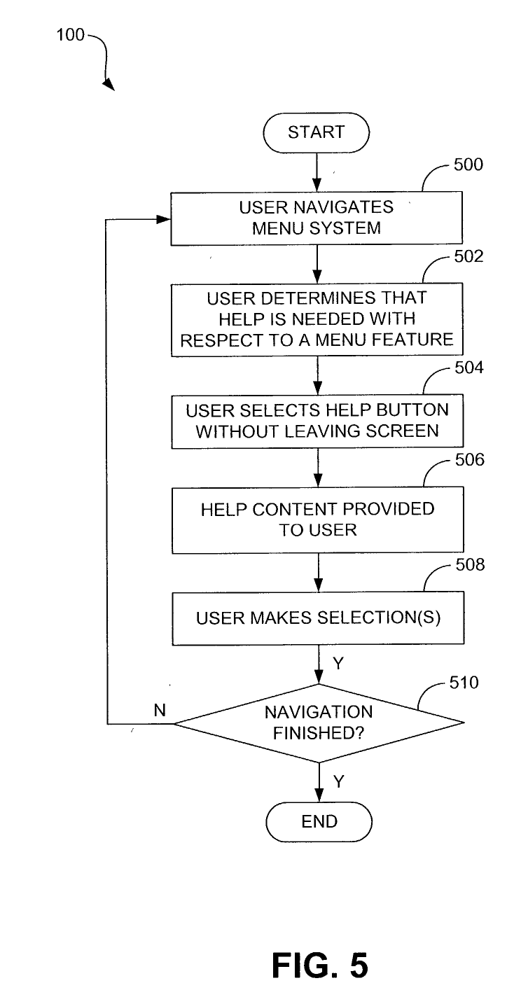

As noted above, it is desired to be able to receive help regarding an electrical device display feature without having to navigate to a separate menu system screen or layer and later return to the feature after help has been obtained. With the systems described above, however, such help can be obtained without leaving the presently viewed menu system screen or layer. An example of operation of the system 100 in facilitating the provision of such help is provided in FIG. 5. Beginning with block 500 of this figure, the user navigates the menu system of the electrical device display 106. This navigation may comprise selecting various onscreen features so that various different display screens are presented to the user. At some point during this navigation the user may determine that help is needed, as indicated in block 502. Such a determination may, for instance, be due to encountering a display feature, such as an onscreen button, with which the user in unfamiliar. Alternatively, the determination may, for example, be due to encountering a familiar feature, but realizing more information is desired regarding that feature.

In any case, once it is determined that help is needed, the user selects a help button without leaving the presently displayed screen, as indicated in block 504. Accordingly, the user need not back track through several menu system screens before a help request can be communicated. As described in greater detail below, the help button may comprise an actual, physical button presented to the user on the device control panel, or an onscreen, virtual “button” that is presented to the user in the electrical device display. At this point, help content is provided to the user in the electrical device display, as indicated in block 506. This help content can comprise any one or a combination of text, graphics, images, video, or the like. In addition, this help content can include audio instructions where the electrical device includes an audio generation device such as a speaker.

Once this help has been provided, the user can make any desired selections, as indicated in block 508. These selections may comprise a selection pertaining to an electrical device action (e.g., a print command), or a selection through which further navigation is achieved. Next, with reference to decision block 510, it is determined whether the user navigation is finished. If so, flow is terminated. If further navigation is desired, flow returns to block 500 and the user navigates the menu system and, if further help is needed, the above flow repeated.

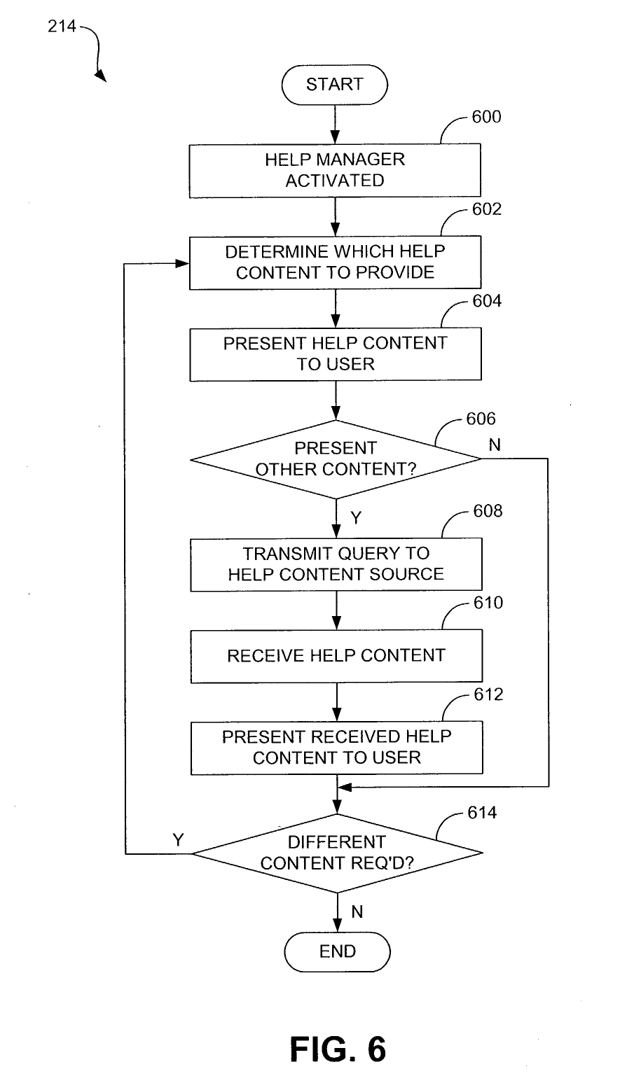

FIG. 6 illustrates an example of operation of the help manager 214 of the electrical device in facilitating the provision of help to a user. Beginning with block 600 of this figure, the help manager 214 is activated. This activation normally occurs in response to the selection of a help button by the user. In one embodiment, the user may have selected an actual, physical help button (e.g., button 108 of FIG. 1) provided on a control panel of the electrical device. In another embodiment, the user may have selected an onscreen, virtual “button” (e.g., button 410 of FIG. 4) that is substantially always visible, and therefore accessible, in the electrical device display irrespective of the menu system layer or screen at which the feature is located. In either case, the screen presented in the electrical device display is not disturbed (i.e., no navigation to other menu system screens is necessary) so that the user need neither memorize the name of a feature about which help is desired or relocate a feature after a display screen containing it is exited.

Activation of the help manager 214 may occur in other ways. For instance, if the manager 214 has been configured to automatically provide help content to the user for certain (e.g., new) features presented in the electrical device display, the manager may be activated when the user navigates to that feature. In another example, help may be provided where it appears, from a large amount of user navigation, that the user is confused as to a given display feature.

Once activation has occurred, the help manager 214 determines which help content is to be provided, as indicated in block 602. This determination is made in relation to one or more features that are present in the current screen shown in the electrical device display. For instance, with reference to the example of FIG. 4 discussed above, the help manager 214 may determine that help content is to be provided for one or more of the Printer Configuration Menu, Printing Menu, Paper Handing Menu, and the Print Quality Menu. This determination is made with reference to the various help files 216 contained by, or accessible to, the help manager 214.

After the determination has been made as to what help content to provide, the content is presented to the user, as indicated in block 604. Again, this content may comprise any one or a combination of text, graphics, images, video, audio, or the like. Regardless, however, the help content is specific to at least one onscreen feature. This content can, for instance, be presented in a “float-over” box that overlays the feature in question. For example, in the example of FIG. 8, a float-over box 800 appears over the Printer Configuration Menu button 402 and states that the menu button “Provides information regarding printer configuration including RAM disk size, powersave options, jam recovery options, etc.”

Where the float-over box 800 is large enough to overlay more than one onscreen feature (e.g., button), the feature to which the box pertains may be identified with an appropriate indicator, such as the black arrow shown in FIG. 8. In circumstances where multiple features are provided in any viewed display screen, the user may identify a particular feature for which help is to be provided by selecting the feature using the help button or another button. For instance, where multiple virtual buttons are provided as in FIG. 8, the user may designate a particular feature by repeatedly selecting the help button (either physical or virtual) until the desired feature is highlighted or otherwise indicated. Where only limited help content is to be provided for each feature presented in the display screen, separate float-over boxes may be simultaneously be provided for each feature.

FIG. 9 illustrates another example manner in which to present help content to the user. In this example, a pop-up window 900 appears that can be used to access help content for each feature presented in the display screen. For instance, in the example of FIG. 9, help topics are indicated as being available for each of the Printer Configuration Menu, the Printing Menu, and the Paper Handling Menu. Any topics not viewable in the window 900 due to space limitations may be accessed using an appropriate navigation device, such as a scroll bar 902. Once the desired topic is located, it may simply be selected, for instance by tapping the electrical device display (where the display is touch-sensitive) or depressing an appropriate button provided on the control panel (where the display is not touch-sensitive).

Once the help content has been provided to the user, it can be determined whether more help content is desired, as indicated in decision block 606. For instance, if somewhat limited help content is stored within the electrical device memory (e.g., text only) and more content is desired (e.g., graphics), help content from an appropriate content source may be obtained. The determination as to whether more help content is needed may be made with reference to a further help request or a response to a query to the user as to whether more help is needed.

If no such other help content is desired, flow continues to decision block 614 described below. If, on the other hand, other help is desired, flow continues to block 608 at which a help content query is transmitted to a help content source using the communication module 218. By way of example, this content source may comprise a local computing device (e.g., PC 110), or a remote computing device (e.g., server 112). In the latter case, the computing device may comprise a print server, for example in a network printer scenario, or a Web server, for example where the source is a Web site of the electrical device manufacturer. Where the computing device is local, the query may comprise, for example, one or more printer control language (PCL) command. Alternatively, where the computing device is remote, the query may comprise, for example, one or more simple network management protocol (SNMP) command. In any case, the query specifies the electrical device display feature or features for which help content is needed.

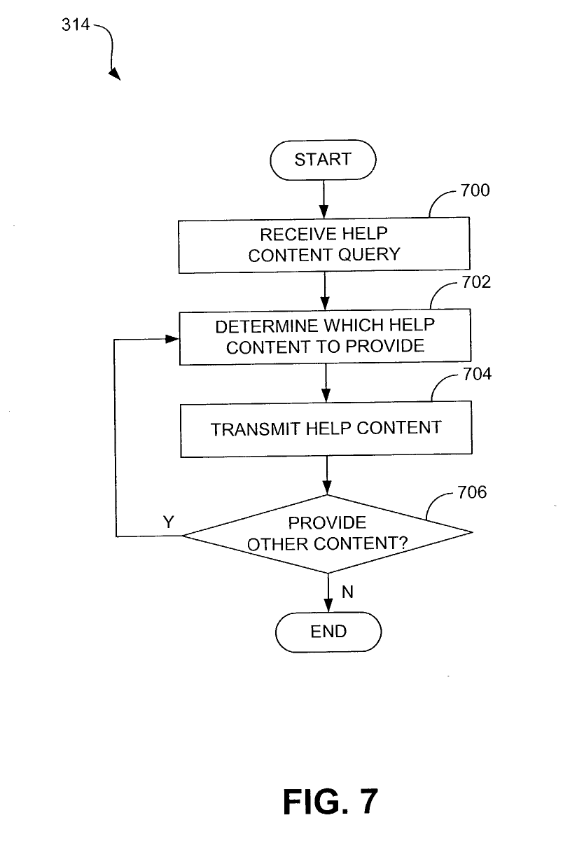

With reference now to FIG. 7, the help content download manager 314 of the content source (e.g., computing device 110 or 112) receives the help content query, as indicated in block 700. Once the query is received, the download manager 314 determines which help content to provide, as indicated in block 702. By way of example, this determination is made with reference to the help file table 318 using the information provided by the help manager 214 (e.g., one or more tags) to locate one or more help files 316 to provide. Next, the appropriate help files 316 can be transmitted, as indicated in block 704, so that the help content can be provided to the user. Typically, this content is transmitted back to the electrical device for presentation in the electrical device display. Alternatively, however, the content can be provided to a local computing device (e.g., PC 110) for presentation with that device. For instance, where the content source comprises a Web server and the content comprises a video sequence that would not display well in the electrical device display, the video sequence can be transmitted to the local computing device for playing on a monitor of the local computing device. Finally, with reference to decision block 706, it can be determined whether more help content is required.

Assuming content is provided to the electrical device, and returning to FIG. 6, the help content is received, as indicated in block 610, and then is presented to the user, as indicated in block 612. Again, the content may be presented in the electrical device display. At this point, it is determined whether different help content is required, as indicated in decision block 614. If not, flow is terminated. If so, however, flow returns to block 602 at which it is determined which help content to provide.

While particular embodiments have been disclosed in detail in the foregoing description and drawings for purposes of example, it will be understood by those skilled in the art that variations and modifications thereof can be made without departing from the scope of the invention as set forth in the following claims.

What is claimed is:

1. A method for obtaining help regarding a feature presented in an electrical device display, comprising:
navigating screens of a menu system presented in an electrical device display;
selecting a help button that is accessible regardless of the current screen that is presented; and
receiving help content pertinent to a feature presented in the current screen.

2. The method of claim 1, wherein the step of navigating comprises selecting various features presented in the display to reach different layers of the menu system.

3. The method of claim 1, wherein the step of selecting a help button comprises depressing an actual, physical help button provided on a control panel of the electrical display.

4. The method of claim 1, wherein the step of selecting a help button comprises selecting an onscreen, virtual help button presented in the electrical device display.

5. The method of claim 1, wherein the step of receiving help content comprises being presented help content displayed in the display.

6. The method of claim 5, wherein the step of receiving help content further comprises being presented with at least one float-over box that contains help information.

7. The method of claim 5, wherein the step of receiving help content further comprises being presented with a pop-up window that contains help information.

8. The method of claim 5, wherein the content was obtained from a remote computing device via a network connection.

9. A method for providing help to a user of an electrical device display, comprising:
receiving a help request registered by the user by selection of a help button;
determining help content relevant to at least one feature that is currently displayed in the electrical device display; and
presenting help content to the user that has been determined to be relevant to the at least one feature.

10. The method of claim 9, wherein the step of receiving comprises receiving a help request registered by the user by depression of an actual, physical help button.

11. The method of claim 9, wherein the step of receiving comprises receiving a help request registered by the user by selection of an onscreen, virtual help button.

12. The method of claim 9, wherein the step of presenting help content comprises displaying help content in the electrical device display.

13. The method of claim 12, wherein the step of presenting help content further comprises displaying at least one float-over box that contains help information.

14. The method of claim 13, wherein the step of presenting help content further comprises displaying a pop-up window that contains help information.

15. The method of claim 9, further comprising the step of collecting help content from a separate content source prior to presenting help content.

16. The method of claim 15, wherein the step of collecting comprises transmitting a help content query to the content source and receiving help content from the content source.

17. A system for providing help to a user of an electrical device display, comprising:
logic configured to detect a help request;
logic configured to determine at least one feature currently presented in the electrical device display and identify help content relevant to that feature; and
logic configured to display help content relevant to the at least one feature in the electrical device display.

18. The system of claim 17, wherein the logic configured to detect a help request comprises logic configured to detect depression of an actual, physical help button.

19. The system of claim 17, wherein the logic configured to detect a help request comprises logic configured to detect selection of an onscreen, virtual help button.

20. The system of claim 17, wherein the logic configured to display comprises logic configured to display at least one float-over box.

21. The system of claim 17, wherein the logic configured to display comprises logic configured to display a pop-up window.

22. The system of claim 17, further comprising logic configured to present a virtual help button in the electrical device display that appears regardless of what menu system layer is currently visible in the display.

23. The system of claim 17, further comprising the logic configured to collect help content from a separate content source.

24. An electrical device, comprising:
a control panel that includes a display and an actual, physical help button;
a processing device; and
memory that includes a help manager that is configured to detect a depression of the help button, determine help content relevant to at least one feature presented in the display, and display help content relevant to the at least one feature in the electrical device display.

25. The device of claim 24, wherein the help manager is further configured to display at least one float-over box that contains help information.

26. The device of claim 24, wherein the help manager is further configured to display a pop-up window that contains help information.

27. The device of claim 24, wherein the help manager is further configured to collect help content from a separate content source.

28. An electrical device, comprising:
a control panel that includes a display and an actual, physical help button;
a processing device; and
memory that includes a help manager that is configured to display an onscreen, virtual help button in the control panel display regardless of what display screen is presented in the display, detect selection of the virtual help button, determine help content relevant to at least one other feature also presented in the display, and display help content relevant to the at least one other feature in the electrical device display.

29. The device of claim 28, wherein the help manager is further configured to display at least one float-over box that contains help information.

30. The device of claim 28, wherein the help manager is further configured to display a pop-up window that contains help information.

31. The device of claim 28, wherein the help manager is further configured to collect help content from a separate content source.
